(19) United States
(12) Patent Application Publication
(10) Pub. No.: US 2025/0361921 A1
(43) Pub. Date: Nov. 27, 2025

(54) Wire Rope Clamp for a Wire Rope, Wire Rope with Wire Rope Clamp and Method of Clamping a Wire Rope Clamp onto a Wire Rope

(71) Applicant: Nemag IP B.V., Zierikzee (NL)

(72) Inventors: Leendert Gommert VAN KOEVERINGE, Zierikzee (NL); Jacob Johannes VAN BURG, Zierikzee (NL); Michel CORBEAU, Zierikzee (NL)

(21) Appl. No.: 18/875,046

(22) PCT Filed: Jun. 16, 2023
(86) PCT No.: PCT/NL2023/050337

§ 371 Date: Dec. 13, 2024

(30) Foreign Application Priority Data
Jun. 16, 2022 (NL) 2032191

(51) Int. Cl. F16G 11/04

(52) U.S. Cl. CPC F16G 11/048

(57) ABSTRACT

A wire rope clamp for clamping a wire rope is provided, comprising a holder provided with an opening for receiving a rope and a rope wedge channel, a rope wedge arranged in the rope wedge channel, the rope wedge comprising a rope clamping surface and a wedging surface, the holder further being provided with a rope supporting surface and with a wedge countering surface. A wedge countering surface of the holder extends along the wedging surface of the rope wedge to in use cooperate with the wedging surface of the rope wedge. The rope clamping surface of the rope wedge frictionally engages the rope section with a first amount of friction, and the wedging surface of the rope wedge frictionally engages the wedge countering surface with a second amount of friction, the second amount of friction being lower than the first amount of friction.

The invention generally relates to clamping of wire rope.

Wire ropes, also known as steel cables, include strands of metal wire twisted into a rope. Such wire ropes may be used dynamically. e.g. for lifting and hoisting or for the transmission of mechanical power, or statically, e.g. for suspension or other transmission of force. Wire ropes as discussed herein typically have carbon steel wires. Wire ropes as discussed herein typically have a diameter of at least 10 mm, and the wires typically have a diameter of at least 0.5 mm. Wire ropes may even have a diameter of at least 20 mm, at least 25 mm, or even 40 mm or more or even 60 mm or more.

Wire ropes typically include connectors to connect the rope, e.g. an end connector to connect end of the rope to a connection point, e.g. a fixed mount or an attachment point of a tool. As the wire rope is built up of rope-laid bundles of relatively fragile individual strands of wire, care should be taken that coupling the connector does not unduly impact efficiency, functionality and life span of the rope. This may be achieved by permanently attaching a connector to a wire rope upon manufacture, e.g. through pressing the connector onto the rope, anchoring the connector to the rope or embedding strands of wire of the rope into a connector in a controlled environment.

Sometimes a connector needs to be releasably attached to a wire rope and/or needs to be attached to the wire rope in the field. A typical example is connecting and disconnecting a free end of a closing rope of a crane to a grab in the field, e.g. to switch grabs or replace ropes. In such case the free end of the rope first needs to be threaded through a number of sheaves that provide the necessary reeving pattern for operating the grab before it can be attached to the grab's attachment point. Due to the limited clearance for the rope at the sheaves, the free end of the rope is to be threaded through without its connection in place. In practice, the connection is then made by attaching a clamp to the rope, the clamp carrying the end connection.

Conventionally a wire rope clamp known as a wedge socket is used, which includes a holder that is provided with a rope opening for receiving a wire rope, a rope wedge channel and a rope wedge arranged in the rope wedge channel. In use, the free end of the wire rope is inserted through the rope opening, bent around the wedge and looped back out via the rope opening. Next, the wedge is pulled into the holder using the rope, so that two sides of the rope loop are clamped against the holder.

A disadvantage of the known wire rope clamp is that for of larger diameters, e.g. more than 20 or 40 mm, bending the rope around the wedge may in practice require quite a lot of manpower, time and effort. In addition, releasing the wire rope that is wedged into the holder can also require significant manpower, time and effort.

Alternative rope clamps have been proposed which also include a holder that is provided with a rope opening for receiving a wire rope, a rope wedge channel and a rope wedge arranged in the rope wedge channel. In such clamps a straight free end of the rope may be inserted via the opening into the rope wedge channel, and may subsequently be symmetrically interposed between wedge sections. Upon pulling back of the rope, the wedge sections engage opposite walls of the channel, and wedge sections clamp the rope therebetween. Disadvantages of such clamps include that axial push force transmitted via the wire rope onto the clamp may push the sectioned wedge out of engagement, while under high tensile loads the clamping wedge sections may damage the rope and/or reduce its efficiency.

CN102701042, JPS5977150A, EP0179961A1 and U.S. Pat. No. 5,392,496A1 disclose wire rope clamps in which the wire rope is clamped between two wedges positioned on opposite sides of the wire rope. It has been observed that these wire rope clamps suffer from the disadvantage of the axial push force being transmitted via the wire rope onto the wedges, which may push the wedges out of engagement and/or may damage the rope and/or reduce its efficiency while under high tensile loads.

The invention aims to provide a wire rope clamp that alleviated the above disadvantages, while substantially maintain its advantages. In particular the invention aims to provide a wire rope clamp that can be attached and/or released to the rope relatively easily, in particular in the field, and with limited manpower, time and effort. In addition, the invention aims to provide such wire rope clamp with improved resistant to axial push force transmitted via the wire rope onto the clamp, and/or with which damage to the wire and/or reduction of efficiency under high tensile loads is lessened.

Thereto, the invention provides for a wire rope clamp for clamping a wire rope according to claim 1, comprising:
a holder that is provided with an opening for receiving a rope and a rope wedge channel,
a rope wedge arranged in the rope wedge channel,
the rope wedge comprising a rope clamping surface and a wedging surface, the wedging surface facing away from the rope clamping surface and extending at a rope wedging angle relative to the rope clamping surface,
the holder further being provided with a rope supporting surface and with a wedge countering surface,
the rope supporting surface of the holder extending along the rope clamping surface of the rope wedge to form an interspace therebetween in which in use a rope section, in particular a straight rope section such as a straight free end of a rope, extends that passes through the rope opening into the rope wedge channel of the holder,
the wedge countering surface of the holder extending along the wedging surface of the rope wedge to in use cooperate with the wedging surface of the rope wedge,
wherein the rope clamping surface of the rope wedge is arranged to frictionally engage the rope section with a first amount of friction, and
wherein the wedging surface of the rope wedge is arranged to frictionally engage the wedge countering surface with a second amount of friction, the second amount of friction being lower than the first amount of friction.

By providing for lower friction between the rope wedge and the countering surface than between the rope wedge and the rope, it is relatively easy to pull the rope wedge into engagement by pulling back on the rope. Engagement of the clamp onto the rope can then be performed by simply inserting a straight section of the rope into the clamp via the rope insertion opening, e.g. axial insertion of a free end of the rope through the opening into the rope wedge channel to extend in the interspace between the rope wedge and the holder, and by subsequent pulling back of the rope until slippage between the rope and the holder stops for a given tensile load. The clamping force thus increases with axial load on the rope, and is related to the maximum axial load that has been put on the rope. The lower friction between the rope wedge and the countering surface facilitates disengagement of the rope wedge. Clamping the rope between the rope wedge and the holder increases resistance to axial push force compared to clamping the rope in between two rope wedges. As such, for any wire rope clamp disclosed herein, it is preferred that only a single side of the rope is pressed on via one or more wedges, while an opposite side of the rope is pressed against a non-wedge element, such as the holder.

An amount of friction may in this context be generally defined as an amount of force resisting two objects from moving relative to each other, for example two surfaces from slipping or sliding relative to each other. The amount of friction may be defined by a friction coefficient between two contacting materials. An amount of friction may further be defined by two objects interlocking, which interlocking provides resistance against a relative movement of two objects, such as wire rope and a rope wedge or holder. Two objects may for example interlock when parts of the two objects overlap in a direction transverse to a pulling direction of a force pulling the objects away from each other. Sharp protrusions, profiling and/or grooves may for example be used to interlock two objects, thus increasing an amount of friction. A friction reducing intermediate structure, such as a bearing plate or roller set, may be used to decrease an amount of friction.

By clamping a straight section on the rope in the interspace between the rope clamping surface of the rope wedge and supporting surface of the holder, the wedge clamps the rope directly onto the holder, and is subject to force in two opposing directions only. This allows a flattening of the rope in which strands of wire are repositioned transverse to the clamping force. This prevents loss of rope efficiency due to damage or pinching of individual wires of the rope. Preferably, a portion of the circumference of the wire is left free to facilitate the cross section of the rope to change in form, e.g. two opposing lateral zones of the circumference of the rope in between opposing zones that contact the wedging surface and supporting surface respectively. This way, a clamped rope can be loaded axially until approximately the same breaking load without clamp. Preferably, the wedging surface and the rope supporting surface extend substantially parallel to each other. The rope clamp may be provided with a connector, e.g. an eye or pin to connect the rope, e.g. to connect the rope to a connection point, e.g. a fixed mount or an attachment point of a tool. The rope clamp may also be directly connected to an implement or tool, e.g. a grab at an end of the rope or a stopper attached halfway along the rope. A straight section of rope is generally defined as a section of rope which is not bent back on itself, which would otherwise result in a generally U-shaped or C-shaped rope section. Preferably, for any embodiment disclosed herein, no portion of the rope—at least at or near the clamped end of the rope—is bent back over itself.

The rope wedging angle (α) at which the wedging surface extends relative to the rope clamping surface is beneficially chosen between 3° and 9°, and preferably is 7°.

By providing the wedging surface and/or the wedge countering surface as a bearing surface of a slide bearing structure, the reduced friction between the wedging surface and its countering surface may be implemented relatively easily. Preferably, the slide bearing structure is provided on a body portion of the rope wedge.

By providing the slide bearing structure with at least one of a plastics material, preferably PTFE or Nylon, a composite material, bronze or cast iron a very low friction may be achieved compared to e.g. steel-steel contact, while pressure resistance is maintained.

A body portion of the rope wedge may comprises or may be is made of high strength steel, preferably S690, in particular when a roller set is used for cooperation between the wedging surface and the wedge countering surface. A body portion of the holder may comprises or may be made of mild steel, preferably S355.

The wedging surface and the wedge countering surface may cooperate via a friction reducing intermediate structure, preferably a bearing plate or roller set. Such roller set may e.g. include cylindrical rollers of hardened steel. As an alternative, such intermediate structure may be implemented as a slide plate of a pressure resistant low friction material, e.g. as mentioned above for the slide bearing structure.

By providing the clamping surface of the rope wedge with a groove that in use receives a portion of the mantle surface of the rope, frictional engagement may be facilitated. To further facilitate frictional engagement between the clamp and the rope, a surface of the groove may be provided with a profile to in use grip the mantle surface of the rope. Such profile may e.g. include ridges and/or indentations. Mild profiling is preferred so as to prevent damage to outer wires of the rope. The rope supporting surface is preferably smooth relative to the clamping surface so as to facilitate slippage of the rope relative to the rope supporting surface while the rope pulls the wedging surface into engagement with the wedge countering surface.

The countering surface may be provided on a surface of the holder. In such configuration, a boundary of the wedge channel may be formed by a countering surface on the holder.

The countering surface may alternatively be provided on an auxiliary wedge, forming a releasable part of the holder, and arranged between the rope wedge and the holder. In such configuration, a boundary of the rope wedge channel may be formed by a countering surface on the auxiliary wedge. The auxiliary wedge may in use form part of the holder. As such, it will be understood that at least in use embodiments of the holder may consist of a single body, such as a body portion, or the holder may comprise multiple bodies which may be connected or may in use at least have contacting surfaces. For example, the auxiliary wedge may be a releasable part of the holder. For example, in use, an auxiliary countering surface of a body portion of the holder may contact an auxiliary wedging surface of the auxiliary wedge.

Such auxiliary wedge may be used as an option to facilitate disengagement of the clamp, and may comprises an auxiliary wedging surface that extends along a supporting surface of the holder to in use cooperate with said supporting surface of the holder. The auxiliary wedging surface may face away from the wedge countering surface and may extend at an auxiliary wedging angle (β) relative to wedge countering surface. The auxiliary wedging angle at which the wedging surface extends relative to the rope clamping surface is beneficially chosen between 7° and 20°, and preferably is 12°.

The rope wedge and the auxiliary wedge may then extend at a relatively large total wedging angle to facilitate release of the wedges. To counteract unintentional disengagement of the wire rope clamp during use, the rope wedge and/or the auxiliary wedge may be secured to the holder via a releasable securing structure. Preferably only the auxiliary wedge is secured to the holder. Such releasable structure may be a securing pin, screw or bolt, but may alternatively or in addition include a movable securing catch.

The invention further provides for a wire rope comprising a wire rope clamp in any of the variants as set out above or discussed below, wherein a rope section, in particular a straight free end of the rope, passes through the rope opening into the rope wedge channel of the holder and is clamped in the interspace between the rope wedging surface of the rope wedge and the rope supporting surface of the holder and wherein the rope clamping surface of the rope wedge frictionally engages the rope section with a first amount of friction, and wherein the wedging surface of the rope wedge frictionally engages the wedge countering surface with a second amount of friction, the second amount of friction being lower than the first amount of friction.

To facilitate engagement of the wire rope clamp onto the wire rope, a portion of the rope section extending beyond the rope wedge may be provided with an auxiliary clamp to entrain the rope wedge and pull it into engagement upon retraction of rope through the rope entrance opening.

In addition, the invention provides for a method of clamping a wire rope clamp onto a wire rope using a wire rope clamp in any of the variants as set out above, wherein a section of the rope, in particular a straight free end of the rope, is inserted through the rope entrance opening of the holder of the rope clamp into the rope wedge channel so that a section of the rope to extends through the interspace between the rope clamping surface of the rope wedge and the rope supporting surface of the holder, and wherein the rope is retracted so that the rope engages the rope wedge via the rope clamping surface and entrains the rope wedge so that the wedging surface of the rope clamp is pulled into engagement with the wedge countering surface and the rope clamping surface of the rope wedge clamps the section of the rope onto the rope supporting surface of the holder.

In general, the shape of the rope clamping surface may be different from an outer shape of the wire rope, to prevent a form closed connection to be formed by the rope clamping surface and the outer shape of the wire rope. Instead, it is preferred that a force connection based on friction is achieved between the rope clamping surface and the wire rope.

When clamping a wire rope clamp onto a wire rope, as an option applicable to any method disclosed herein, it may be preferred to after inserting the rope through the rope entrance opening, and prior to the rope being retracted, couple the rope to the rope wedge, and subsequently bending the rope towards the rope wedge or at least bend the rope relative to the rope wedge. The bend formed by bending the rope may be used to retract the rope wedge further into the rope wedge channel when the wire rope is retracted in order to clamp the wire rope.

For example, the rope can be coupled to the rope wedge by a restriction member connected to or formed by a rear end of the rope wedge. The restriction member is arranged to restrict movement of the wire rope relative to the rope wedge when bending the rope, to allow the rope to be bent instead of deflecting away from the rope wedge. As an option, the rope may be inserted into a passage of the restriction member prior to bending the rope towards the rope wedge.

The present disclosure also contemplates a method for unclamping a wire rope clamp from a wire rope, wherein the wire rope is clamped between a rope supporting surface of a holder of the wire rope clamp and a rope clamping surface of a rope wedge, which rope wedge is at least partially positioned in a rope wedge channel of the holder together with an auxiliary wedge. The method comprises steps of releasing a clamped connection between the auxiliary wedge, the holder, and the rope wedge, and removing the wire rope from the rope wedge channel, in particular in that order.

By virtue of being able to unclamp the wire rope clamp from the wire rope by releasing the clamped connection between the auxiliary wedge, the holder, and the rope wedge, the auxiliary wedge may be designed with a different purpose than the rope wedge: whereas the rope wedge can aid in clamping the wire rope when the wire rope is retracted so that the rope engages the rope wedge, the auxiliary wedge may aid in being able to conveniently release the wire rope from the wire rope clamp.

It will be understood that the wire rope clamp from which the wire rope in unclamped may be any wire rope clamp disclosed herein. The wire rope clamp may have been clamped onto the wire rope using any method disclosed herein.

Preferably, but not necessarily, the method further comprises removing the auxiliary wedge and the rope wedge from the rope wedge channel.

The invention will further be elucidated on the basis of exemplary embodiments which are represented in the drawings. The exemplary embodiments are given by way of non-limitative illustration of the invention.

In the drawings:

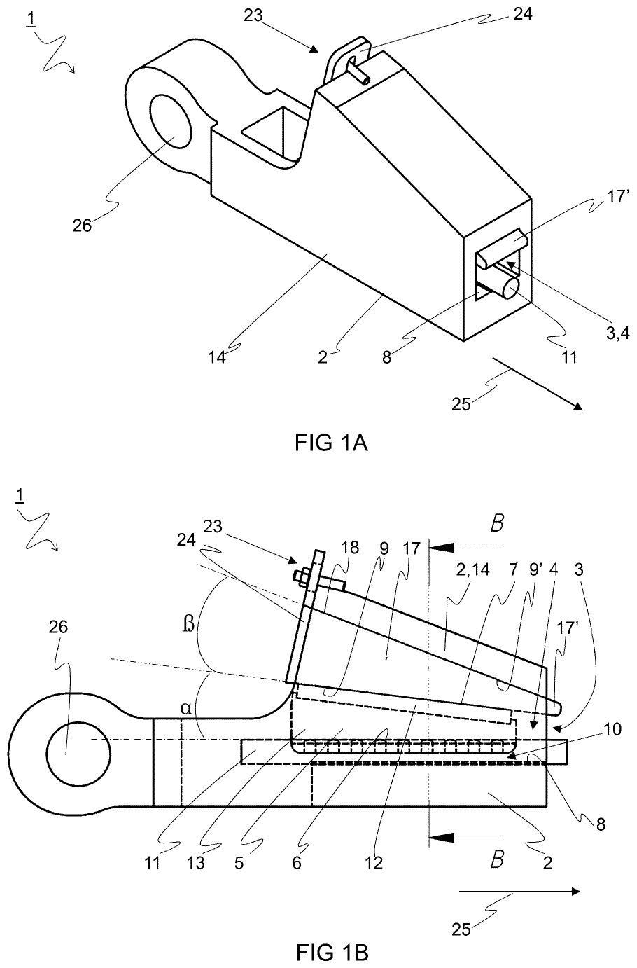

FIG. 1A shows an embodiment of a wire rope clamp in a schematic isometric view;

FIG. 1B shows the wire rope clamp in a side view;

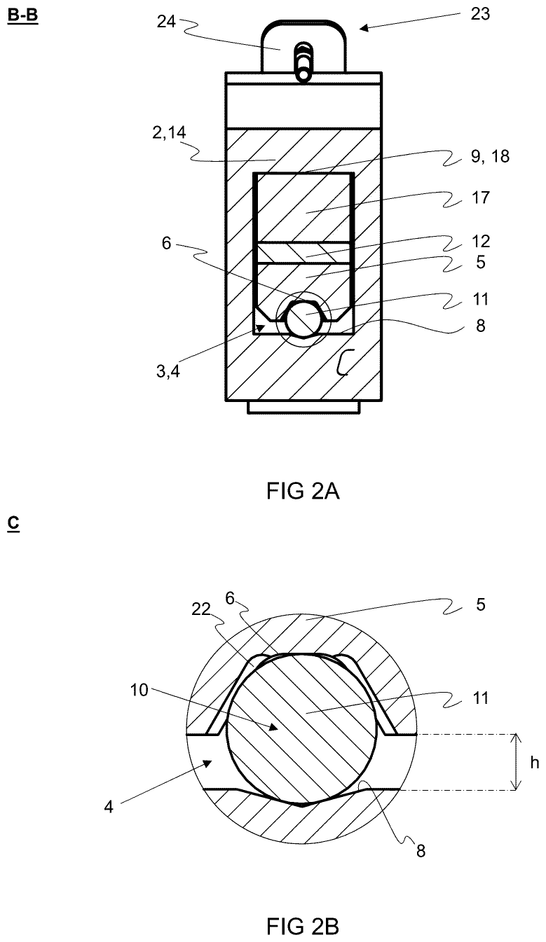

FIG. 2A shows the wire rope clamp in a section view along line B-B;

FIG. 2B shows a detailed view C;

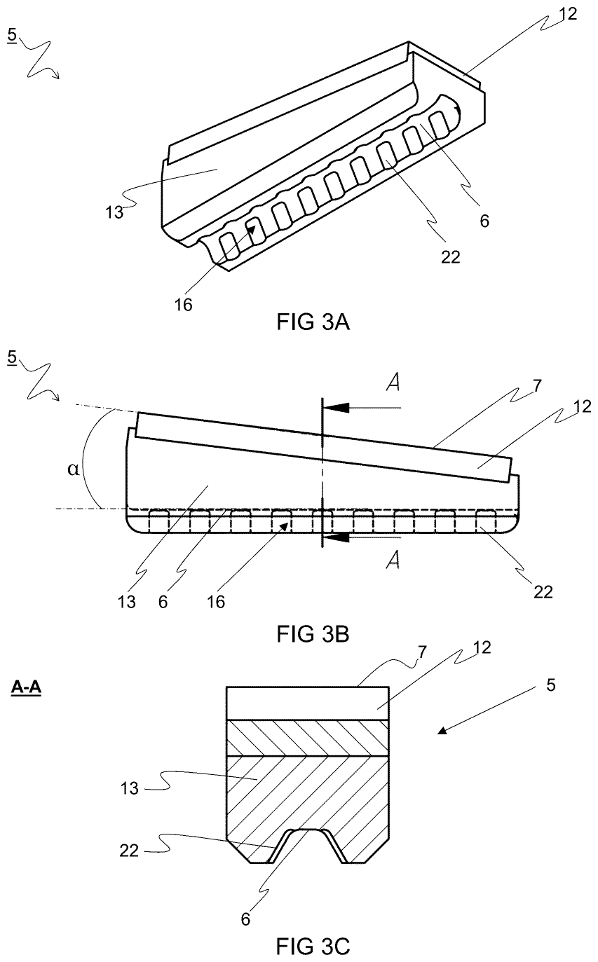

FIG. 3A shows an embodiment of a rope wedge in a isometric bottom view;

FIG. 3B shows the rope wedge in a side view;

FIG. 3C shows a section view of the rope wedge along line A-A;

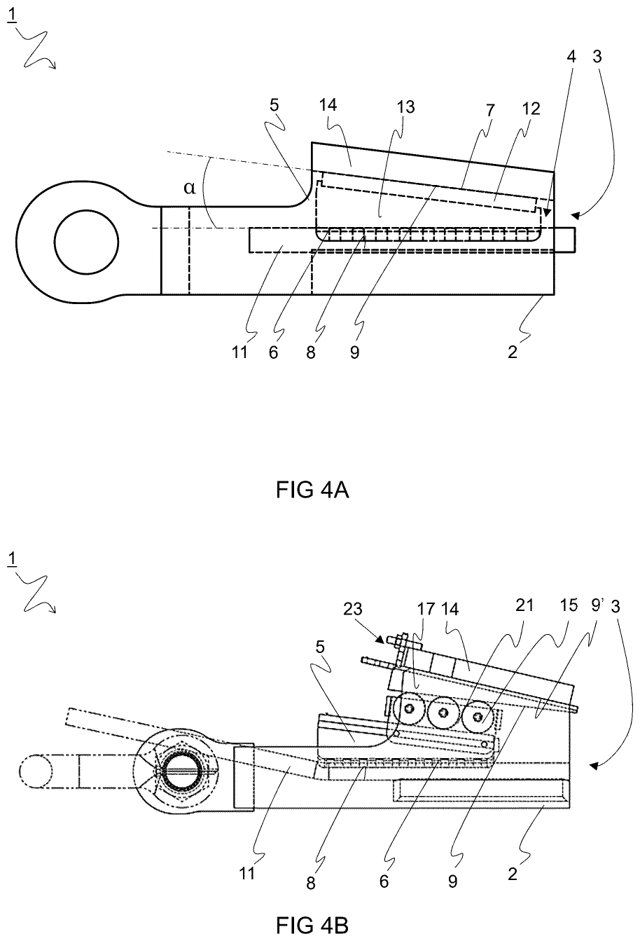

FIG. 4A shows an alternative embodiment of a wire rope clamp;

FIG. 4B shows another alternative embodiment of a wire rope clamp;

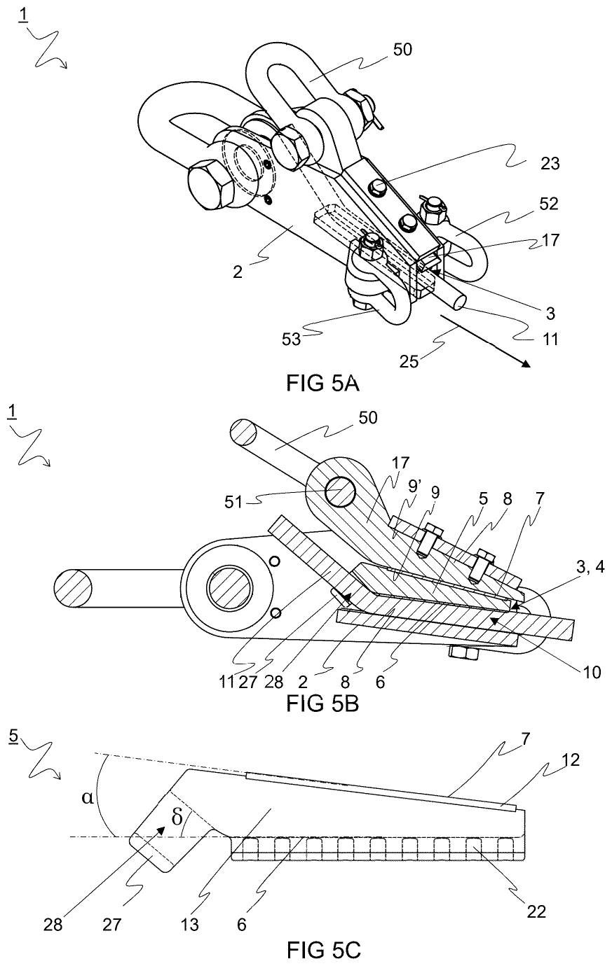

FIGS. 5A and 5B show another embodiment of a rope clamp 1, respectively in an isometric view and a section view;

FIG. 5C shows a detailed section view of a particular embodiment of a rope wedge; and

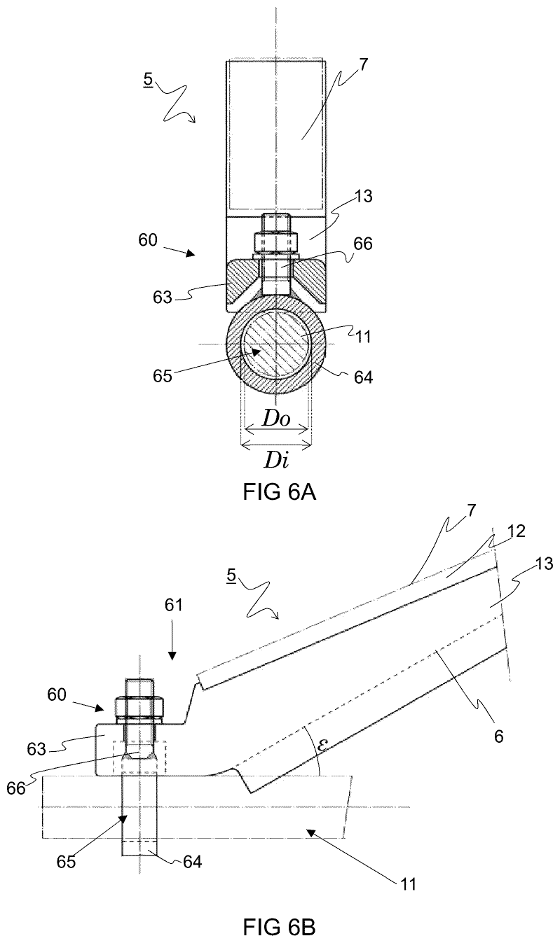

FIG. 6A shows a rear view, and FIG. 6B shows a partial side view of a rope wedge which can be used in any rope clamp disclosed herein.

FIG. 1A shows an embodiment of a wire rope clamp 1 in a schematic isometric view. FIG. 1B shows the wire rope clamp 1 in a side view, with dashed lines generally indicating components which are not directly visible. The wire rope clamp 1 is clamped onto a wire rope section 11, which is particular is a straight free end of a wire rope, which for example may be a hoisting rope. The rope section 11 has been inserted through a rope entrance opening 3 of a holder 2 of the rope clamp 1. It will be understood that only a small part of the total length of the wire rope is depicted in the figures for clarity of these figures.

The holder 2 comprises a rope wedge channel 4, in which at least part of a rope wedge 5 is positioned. The rope wedge channel 4 is defined between a rope clamping surface 8 and a wedge countering surface 9 of an auxiliary wedge 17, which auxiliary wedge 17 is as such considered to be comprised by the holder 2. The holder 2 further comprises a holder body portion 14, which is formed by a body separate than the auxiliary wedge 17 such that the auxiliary wedge 17 is moveable relative to the holder body 14 at least during assembling of the rope clamp 1. The rope clamping surface 8 and the wedge countering surface 9 face each other and are oriented at an angle relative to each other. In particular, the rope wedge channel 4 is tapered in a direction corresponding to a tensioning direction 25 of the wire rope, as can be seen in the side view of FIG. 1B. In other words, the rope wedge channel 4 is tapered towards the opening 3 of the holder 2.

Preferably, as an option for example depicted in FIG. 1A, the holder 2 is formed as a solid body—i.e. a body without internal degrees of freedom such as hinging parts—at least around the rope wedge channel 4. The wire rope 11 in such cases has to be inserted through the rope entrance opening 3 in order to pass through the rope wedge channel 4 from the front to the rear of the holder 2.

The auxiliary wedge 17 has a tapered shape, and in use is tapered towards the direction corresponding to a tensioning direction 25 of the wire rope. The tapered shape of the auxiliary wedge 17 is obtained by virtue of the angle between a wedge countering surface 9 of the auxiliary wedge 17 and an auxiliary wedging surface 18 on an opposite side of the auxiliary wedge 17.

The auxiliary wedge 17 in this embodiment provides that an angle a between the rope clamping surface 6 and the wedge countering surface 9 can differ from an angle α+β between the rope clamping surface 6 and the auxiliary wedge countering surface 9′ of the holder 2. The angle between the rope clamping surface 6 and the auxiliary wedge countering surface 9′ of the holder 2 thus corresponds to the sum of angles α and β indicated in FIG. 1B. As such, a different amount of friction may be obtained between the wedging surface 7 of the rope wedge 5 and the wedge countering surface 9, and between the auxiliary wedging surface 18 of the auxiliary wedge 17 and the auxiliary wedge countering surface 9′ on the holder body portion 14. Also the angle between the auxiliary wedge countering surface 9′ and the rope clamping surface 6 may be changed, for example by changing one or both of angles α and β.

As can be seen in particular in the section view of FIG. 1B, the rope section 11 is positioned in an interspace 10 formed between the rope supporting surface 8 of the holder 2 and a rope clamping surface 6 of the rope wedge 5. The rope supporting surface 8 and the rope clamping surface 6 preferably extend substantially parallel. This provides for a clamping force onto the wire rope section 11 which is substantially perpendicular to an elongation direction of the wire rope section. This in turn may beneficially allow strands of wire comprised by the wire rope section 11 to reposition relative to each other, thus allowing flattening of the wire rope section 11. Preferably, part of the circumference of the wire rope section 11 is left free to facilitate the cross-sectional shape of the wire rope section 11 to change form.

As shown in FIG. 1B, within the wire rope clamp 1, different surfaces of different components can be forced against each other, in particular when the rope section 11 is tensioned in the tensioning direction 25. The rope section 11, when tensioned in a tensioning direction indicated with arrow 25 in FIG. 1A, is clamped in the holder 2. In particular, the rope section 11 is preferably directly clamped against the rope supporting surface 8 of the holder 2, and indirectly clamped against the auxiliary wedge countering surface 9′ via the rope wedge 5 and the auxiliary wedge 17.

In use, when the wire rope section 11 has been positioned between the rope supporting surface 8 of the holder 2 and the clamping surface 6 of the rope wedge 5, the wire rope section 11 is pulled in the tensioning direction 25. During this pulling, for example by virtue of gravity and/or manual positioning, the wire rope section 11 contacts the rope supporting surface 8 as well as the clamping surface 6. Initially, the wire rope section 11 may slip relative to the rope supporting surface 8 and even relative to the clamping surface 6. However, as the rope wedge 5 moves further towards the opening 3 of the holder 2—by virtue of the wedge surface 7 slipping relative to the wedge countering surface 9—the wire rope section 11 only slips with the rope supporting surface 8 and substantially doesn't slip with the clamping surface 6 of the rope wedge 5—the wire rope section 11 thus pulls the rope wedge 5 further towards the opening 3.

As the rope wedge 5 is pulled further towards the opening 3, the clamping force of the rope wedge 5 pressing the wire rope section 11 against the rope supporting surface 8 increases to a level that the wire rope section 11 doesn't slip anymore relative to the rope wedge 5.

The initial slip between the wedging surface 7 and the wedge countering surface 9 is achieved by a first amount friction between the rope clamping surface 6 and the rope section 11 being higher than a second amount of friction between wedging surface 7 of the rope wedge 5 and the wedge countering surface 9. A third amount of friction may be defined between the rope section 11 and the rope supporting surface 8. Initially, as the wire rope section 11 is tensioned, the third amount of friction is preferably lower than the first amount friction between the rope clamping surface 6 and the rope section 11—allowing the wire rope section 11 to slip relative to the rope supporting surface 8 while the wire rope section 11 frictionally engages the rope wedge 5. In use, i.e. when the wire rope section 11 is tensioned and the wire rope is used for example for hoisting, the third amount of friction is sufficient to prevent the wire rope section 11 from slipping relative to the rope supporting surface 8. It will be understood that the third amount of friction between the rope section 11 and the rope supporting surface 8 depends on the clamping force clamping the rope section 11 between the rope supporting surface 8 and the rope clamping surface 6, which clamping force is oriented perpendicular to the rope supporting surface 8, and depends on the friction coefficient between the rope section 11 and the rope supporting surface 8. To release the wire rope section 11 from the wire rope clamp 1, the tension on the wire rope section 11 is preferably fully released. Next, one or both of the rope wedge 5 and the auxiliary wedge 17 are moved away from the opening 3 to relieve the clamping force squeezing the wire rope section 11 between the rope clamping surface 6 of the rope wedge 5 and the rope supporting surface 8 of the holder 2. To move the rope wedge 5 and/or the auxiliary wedge 17, the rope wedge 5 and/or the auxiliary wedge 17 may be impacted, for example using a hammer or other impact tool. To this end, preferably part 17′ of the auxiliary wedge 17 protrudes out of the opening 3, as can be seen for example in FIG. 1A, to make impacting the auxiliary wedge 17 more convenient. When the wire rope clamp 1 comprises a releasable securing structure 23, it may be required to release this releasable securing structure 23 prior to impacting the auxiliary wedge 17. Additionally or alternatively, the wire rope section 11 may be pulled in an opposite direction than the tensioning direction in use, in order to move the rope wedge 5 and/or the auxiliary wedge 17 in a direction away from the opening 3.

A rope wedging angle α between the wedging surface 7 and the rope clamping surface 6 is indicated in FIG. 1B. Preferably, the angle α is chosen between 3° and 9°, in particular between 5° and 8°, and preferably 7° or approximately 7°. An angle β is also indicated in FIG. 1B as the auxiliary wedging angle between the auxiliary wedging surface 18 and the wedge countering surface 9. The angle β is preferably chosen between 7° and 20°, in particular between 10° and 15°, and preferably is 12° or approximately 12°.

To prevent the auxiliary wedge 17 from being pushed away from the opening 3, the auxiliary wedge 17 is secured to the holder 2 via a releasable securing structure 23. In this particular embodiment, the releasable securing structure 23 comprise a locking plate 24 secured to the holder 23 using a bolted connection. The locking plate 24 is aligned with at least part of the auxiliary wedge 17, and thus prevents the auxiliary wedge 17 from releasing—in particular when the tension load on the rope 11 is low or even absent, but also in examples when the tension load in the rope 11 is high, which may result in a force on the auxiliary wedge 17 with a force component in a direction opposite to the tensioning direction 25. A force having a force component in a direction opposite to the tensioning direction does not necessarily mean that the direction of the force is in line with the tensioning direction—the force vector of the force on the auxiliary wedge may be described as the sum of: a force component in a direction opposite to the tensioning direction and in line with the tensioning direction, and another non-zero force component in a direction perpendicular to the tensioning direction. It will thus be understood that in examples, the auxiliary wedge may not be self-locking. In further embodiments, the locking plate 24 may also be aligned with at least part of the rope wedge 5 to prevent the rope wedge 5 from unintentionally releasing.

The auxiliary wedge 17 and/or rope wedge 5 may be pushed away from the opening 3 due to the clamping force on the auxiliary wedge 17 being oriented in a direction perpendicular to the auxiliary wedge countering surface 9′ and the clamping force on the rope wedge 5 being oriented in a direction perpendicular to the wedge countering surface 9.

The wire rope clamp 1 is in the example of FIGS. 1A and 1B provided with a connection eye 26 to connect the rope 1 to a connection point, e.g. a fixed mount or an attachment point of a tool.

FIG. 2A shows a section view over line B-B, which line B-B is indicate in FIG. 1B. FIG. 2A shows the wire rope section 11 clamped in between the rope supporting surface 8 and the clamping surface 6 of the rope wedge 5.

FIG. 2B shows a detailed view C, as is indicated in FIG. 2A. In FIG. 2B, it is visible that the clamping surface 6 of the rope wedge 5 is in this embodiment provided with a groove 22. In use, and as depicted in FIG. 2B, the groove 22 receives a portion of an outer part of the wire rope section 11, which outer part may comprise a mantle surface.

As can be seen in FIGS. 2A and 2B, part of the circumference of the wire rope section 11 does not contact the holder 2 or rope wedge 5. This allows the cross-sectional shape of the wire rope section 11, visible in FIG. 2B, to deform when the wire rope section 11 is clamped in between the rope supporting surface 8 and the rope clamping surface 6. In use, the cross-sectional shape of the wire rope section 11 may hence be non-circular.

As an option not depicted in the figures, at least part of a surface of one or more of the grooves 22 may be provided with ridges, teeth, protrusion, indentations, and/or other surface objects which may increase the amount of friction between the wire rope section 11 and the clamping surface 6 of the rope wedge 5 in which the grooves 22 are provided. The ridges, teeth, protrusion, indentations, and/or other surface objects may form a profile 16 to in use grip the mantle surface of the rope section 11.

The rope supporting surface 8 of the holder 2 is preferably substantially smooth, and hence not provided with surface objects such as ridges, teeth, protrusion, indentations, which may increase the amount of friction between the wire rope section 11 and the rope supporting surface 8 and/or to prevent damaging the mantle surface of the rope 11 when the rope 11 slips over the rope supporting surface 8.

A gap with non-zero height h is preferably present between the clamping surface 6 of the rope wedge 5 and the rope supporting surface 8 of the holder 2. The gap with non-zero height h in use ensures that clamping force is transmitted through the wire rope section 11, and is not directly transmitted between the rope wedge 5 and the holder 2 to ensure that the wire rope section 11 is actually clamped in the wire rope clamp 1.

FIGS. 3A-3C show an embodiment of the rope wedge 5, respectively in an isometric bottom view, side view with dashed lines generally indicating components not directly visible, and a section view over line A-A.

As shown in FIGS. 3A-3C, the rope wedge 5 can comprise a rope wedge body portion 13 and a slide bearing structure 12, which may be connected to the rope wedge body portion 13. The body portion 13 may provide the rope clamping surface 6, and the slide bearing structure 12 may provide the wedging surface 7. The body portion 13 and the slide bearing structure 12 may comprise different materials, optionally with different surface treatments. As such, the friction coefficient of the rope clamping surface 6 and the wedging surface 7 may be tuned independently by choosing different materials and/or surface treatments. In further embodiments, the material of the rope clamping surface 6 may even differ from the material comprised by the body portion 13.

For example, the slide bearing structure 12 may comprise low friction material, whereas the body portion 13 comprises material with a high stiffness against compression. Additionally or alternatively, the holder body portion 9 forming the wedge countering surface 9 or the auxiliary wedge countering surface 9′ may comprise low friction material. When the clamp 1 comprises an auxiliary wedge 17, at least part of one or both of the auxiliary wedging surface 18 and the auxiliary wedge countering surface 9′ may comprise or consist of low friction material. An example of low friction material is composite material, for example comprising woven fibres impregnated with polyester resins—commercially available under the name Teclite. Other examples of low friction materials are bronze, plastics such as thermoplastics, for example PTFE or Nylon, or any other material with a low coefficient of friction. Instead of or in addition to using low friction materials, one or more friction reducing intermediate structures may be used.

Similarly, in embodiments, the holder 2 may comprise a holder body portion 14 comprising different material than parts of the holder 2 providing the rope supporting surface 8 and/or the wedge countering surface 9 or auxiliary wedge countering surface 9′.

FIG. 4A shows a side view of an alternative embodiment of a wire rope clamp 1, comprising a holder 2. In FIG. 4A, dashed section lines generally indicate components inside the holder 2. Contrary to the embodiment of FIGS. 1A and 1B, in this particular embodiment of the wire rope clamp 1, the rope wedge 5 directly contacts the holder body portion 14. In particular, the wedging surface 7 of the rope wedge 5 directly contacts the wedge countering surface 9 of the holder 2. In this embodiment, the boundaries of the wedge channel 4 are formed by the countering surface 9 of the holder 2 and the rope supporting surface 8 of the holder 2.

As such, in particular when a tensioning force is exerted on the wire rope section 11, the wire rope section 11 is clamped between the holder 2 and the rope wedge 5, and the rope wedge 5 is directly clamped between the wire rope section 11 and the holder 2, in particular the wedge countering surface 9 on the holder body portion 14 of the holder 2. Compared to the embodiment shown in FIGS. 1A and 1B, not using an auxiliary wedge may provide for a simpler design, which may be easier to assemble.

The amount of friction with which the rope clamping surface 6 of the rope wedge 5 engages the rope section 11 is preferably higher than the amount of friction with which the wedging surface 7 of the rope wedge 5 engages the wedge countering surface 9 of the holder 2. As such, in use, initially as the wire rope section 11 is tensioned, the rope wedge 5 slips for a longer time relative to the wedge countering surface 9 than the rope wedge slips relative to the rope section 11. This may reduce the risk of the wire rope section 11 being pulled out of the clamp 1 while tensioned.

To lower the amount of friction between the wedging surface 7 of the rope wedge 5 and the wedge countering surface 9, a slide bearing structure 12 is provided. While the slide bearing structure 12 is in the embodiment of FIG. 4A is provided on a body portion 13 of the rope wedge 5, the slide bearing structure 12 may be additionally or alternatively positioned on the holder 2. As such, the wedging surface 7 and/or the wedge countering surface 9 may be provided as a bearing surface of a slide bearing structure 12. Preferably, the bearing surface comprises at least one of a plastics material, preferably PTFE or Nylon, a composite material, bronze or cast iron, or in general any other material which provides a low coefficient of friction in combination with the material of the surface against which the bearing surface is pressed, in combination with being sufficiently pressure resistant.

FIG. 4B shows in side view of yet another alternative embodiment of a wire rope clamp 1, comprising a holder 2. In FIG. 4B, dashed section lines show components inside the holder 2. In the embodiment of FIG. 4B, a set of cylindrically shaped rollers 15 rotationally mounted on a roller frame 21 are provided. The roller frame 21 is connected to the rope wedge 5, and faces away from the rope clamping surface 6. Alternatively, the roller frame 21 may be connected to the auxiliary wedge 17 facing towards the rope wedge 5. As an even further alternative, the wire rope clamp 1 of FIG. 4B does not comprise an auxiliary wedge, and the rollers 15 may be rotationally connected to the holder 2, and may as such provide the wedge countering surface 9. The rollers 15 are an example of a friction reducing intermediate structure.

The rollers 15 may be rotationally connected to the roller frame 21 or even directly to the rope wedge 5 via bearings, such as plain bearings or roller bearings capable of withstanding a compressive load. The rollers 15 provide for a low amount of friction between the rope wedge 5 and the auxiliary wedge 17, which low amount of friction allows the rope wedge 5 to move towards the opening 3 when the clamping is initialised. Preferably, the rollers 15 comprise a hardened steel.

Another example of a friction reducing intermediate structure is a plate of a low friction material, which plate provides the wedging surface 7 or the wedge countering surface 9. In embodiments, two bearing plates may be used as a friction reducing intermediate structure, wherein the plates provide each one of the wedging surface 7 and the wedge countering surface 9, and low coefficient of friction between the wedging surface 7 and the wedge countering surface 9.

FIGS. 5A and 5B show another embodiment of a rope clamp 1, respectively in an isometric view and a section view. FIG. 5C shows a detailed section view of a particular embodiment of a rope wedge 5, which rope wedge 5 is comprised by the rope clamp 1 of FIGS. 5A and 5B.

The rope wedge 5 best depicted in FIGS. 5B and 5C comprises a rope wedge passage 28 through which the rope 11 can extend. The rope wedge passage 28 may be formed by a rear section 27 of the rope wedge 5. The rear section 27 is in use oriented away from the rope opening 3 and/or the rope wedge channel 4. In use, the rope wedge passage 28 may be oriented at an angle relative to the rope wedge channel 4 and/or at an angle 8 relative to the to the rope clamping surface 6, in particular an angle between 5 and 60 degrees, or between 15 and 50 degrees, or even between 30 and 45 degrees. As such, part of the rope 11 may be curved or bent corresponding to the angle between the rope wedge passage 28 and the rope wedge channel 4—as can be seen in FIG. 5B. The rope wedge passage 28 may be fully surrounded by the rear section 27 of the rope wedge 5, or only partially surrounded by the rear section 27 of the rope wedge 5.

When the rope 11 passes through the rope wedge passage 28, and the rope 11 is pulled in the tensioning direction 25, the bend or curve in the rope 11 may aid the rope 11 in pulling the rope wedge 5 towards the rope entrance opening 3, or more in general, in the tensioning direction 25. A method of clamping a wire rope clamp 1 onto a wire rope 11 may hence comprise a step of inserting the rope, in particular a free end of the rope, through the optional rope wedge passage 28 of the rope wedge 5 and bending the rope relative to the rope clamping surface 6, in particular prior to the rope being retracted.

The D-shackle 50 depicted in FIGS. 5A and 5B is optional, and embodiments of the rope clamp 1 are envisioned without said D-shackle 50. In such embodiments, the eye 51 in the auxiliary wedge 17 at which the D-shackle is connected may not be required and may thus be omitted. Also the further D-shackles 52, 53 are optional and may be omitted.

FIG. 6A shows a rear view, and FIG. 6B shows a partial side view, of a rope wedge 5 which can be used in any rope clamp disclosed herein, for example but not limited to the rope clamps depicted in FIGS. 1A, 1B, 4A, 4B, and 5A-5C. FIGS. 6A and 6B also show a rope section 11. The rope wedge 5 comprises a wedge body portion 13 and a slide bearing structure 12, and provides a rope clamping surface 6.

The rope wedge 5 of FIGS. 6A and 6B comprises a restriction member 60, positioned at a rear end 61 of the rope wedge 5 and generally connected to a rear section 63 of the body portion 13. It will be appreciated that in use the rope wedge 5 will be inserted into the holder 2 with a front end first. Any connection element 66 may be used to connect the restriction member 60 to the body portion 13. In alternative embodiments, the restriction member 60 is formed by the rope wedge 5 itself.

In the example of FIGS. 6A and 6B, the connection element 66 allows the passage 65 to be moved relative to rear section 63. This is for example achieved when a threaded connection is formed between the connection element 66 and the rear section 63. In use, the wire rope 11 may be passed through the passage 65, and the passage 65 can subsequently be moved towards the rear section 63 to bend the wire rope.

The restriction member 60 is in general used to couple the rope 11 to the rope wedge 5, in order to allow the rope 11 to be bent relative to the wedge body portion 13, preferably towards the rope clamping surface 6. The example of the restriction member 60 depicted in FIGS. 6A and 6B comprises a restriction body 64 defining a passage 65 for accommodating part of the wire rope 11. Although FIG. 6A shows the passage 65 fully encircled by the restriction body 64, this is not essential. Instead, it is sufficient if the restriction body 64 can sufficiently restrict movement between the wire rope 11 and the wedge body portion 13 to allow the wire rope 11 to be bent towards the wedge body portion 13. For example, it may be sufficient if part of the wire rope 11 is positioned between the rear section 63 of the body portion 13 and the restriction body 64.

From FIG. 6A, it will be appreciated that it is envisioned, but not essential, that an inner diameter Di of the passage 65 is larger than an outer diameter Do of the wire rope 11. This may allow for easy insertion of the wire rope 11 into the passage 65, and through the restriction body 64.

When the wire rope 11 is bent towards the wedge body portion 13, the angle ε is reduced. For example, the angle & may be reduced from an angle between 20 and 40 degrees, for example approximately 30 degrees, to an angle of approximately 0 degrees.

It is noted that the figures are only schematic representations that are given by way of non-limited examples. In the figures, the same or corresponding parts are designated with the same reference numerals.

Many variations will be apparent to the skilled person in the art. For example, embodiments of wire rope clamps are envisioned with or without the auxiliary wedge, and optionally with any embodiment of the slide bearing structure and/or friction reducing intermediate structure.

Such variations are understood to be comprised within the scope of the invention defined in the appended claims.

### LIST OF REFERENCE NUMERALS

1. Rope clamp
2. Holder
3. Rope entrance opening
4. Rope wedge channel
5. Rope wedge
6. Rope clamping surface
7. Wedging surface
8. Rope supporting surface
9. Wedge countering surface
10.Interspace
11.Rope section
12.Slide bearing structure
13.Rope wedge body portion
14.Holder body portion
15.Roller
16.Profile
17.Auxiliary wedge
18.Auxiliary wedging surface
20.Auxiliary clamp (not shown)
21.Roller frame
22.Groove
23.Releasable securing structure
24.Locking plate
25.Tensioning direction
26.Connection eye
27.Rear section of the rope wedge
28.Rope wedge passage
50.D-shackle
51.Eye
52.D-shackle
53.D-shackle
60.Restriction member
61.Rear end
63.Rear section
64.Restriction body
65.Passage
66.Connection element
9′. Auxiliary wedge countering surface
α Rope wedging angle
β Auxiliary wedging angle
h Gap height
δ Angle relative to the to the rope clamping surface
ε Angle between wire rope and wedge body portion
Di Inner diameter
Do Outer diameter

1. Wire rope clamp for clamping a wire rope, comprising:
a holder that is provided with a rope opening for receiving a rope and is further provided with a rope wedge channel,
a rope wedge arranged in the rope wedge channel, the rope wedge comprising a rope clamping surface and a wedging surface, the wedging surface facing away from the rope clamping surface and extending at a rope wedging angle relative to the rope clamping surface,
the holder further being provided with a rope supporting surface and with a wedge countering surface,
the rope supporting surface of the holder extending along the rope clamping surface of the rope wedge to form an interspace therebetween in which in use a rope section, extends that passes through the rope opening into the rope wedge channel of the holder,
the wedge countering surface of the holder extending along the wedging surface of the rope wedge to in use cooperate with the wedging surface of the rope wedge,
wherein the rope clamping surface of the rope wedge is arranged to frictionally engage the rope section with a first amount of friction, and
wherein the wedging surface of the rope wedge is arranged to frictionally engage the wedge countering surface with a second amount of friction, the second amount of friction being lower than the first amount of friction.

2. The wire rope clamp according to claim 1, wherein the rope wedging angle at which the wedging surface extends relative to the rope clamping surface is between 3° and 9°.

3.-5. (canceled)

6. The wire rope clamp according to claim 1, wherein a body portion of the rope wedge comprises or is made of high strength steel, and a body portion of the holder comprises or is made of mild steel.

7.-10. (canceled)

11. The wire rope clamp according to claim 1, wherein the rope supporting surface is smooth relative to the clamping surface so as to facilitate slippage of the rope relative to the rope supporting surface while the rope pulls the wedging surface into engagement with the wedge countering surface.

12. (canceled)

13. The wire rope clamp according to claim 1,
wherein the holder comprises a releasable auxiliary wedge, and the countering surface is provided on the auxiliary wedge, which auxiliary wedge is arranged between the rope wedge and an auxiliary wedge countering surface of the holder.

14. The wire rope clamp according to claim 13, wherein the auxiliary wedge comprises an auxiliary wedging surface that extends along the auxiliary wedge countering surface of the holder to in use cooperate with said auxiliary wedge countering surface of the holder.

15. The wire rope clamp according to claim 13, wherein the auxiliary wedging surface faces away from the wedge countering surface and extends at an auxiliary wedging angle relative to the wedge countering surface.

16. The wire rope clamp according to claim 15, wherein the auxiliary wedging angle at which the auxiliary wedging surface extends relative to the wedge countering surface is between 7° and 20°.

17. The wire rope according to claim 13, wherein the rope wedge and the auxiliary wedge are both at least in part tapered towards the rope opening.

18. The wire rope according to claim 13, wherein part of the auxiliary wedge protrudes out of the rope entrance opening of the holder.

19. The wire rope clamp according to claim 13, wherein the rope wedge and/or the auxiliary wedge is secured to the holder via a releasable securing structure.

20. The wire rope clamp according to claim 1, wherein the rope wedge comprises a rope wedge passage through which at least part of the rope section can extend, which rope wedge passage is oriented at an angle relative to the rope clamping surface.

21. The wire rope comprising a wire rope clamp according to claim 1, wherein a rope section, passes through the rope opening into the rope wedge channel of the holder and is clamped in the interspace between the rope wedging surface of the rope wedge and the rope supporting surface of the holder and wherein the rope clamping surface of the rope wedge frictionally engages the rope section with a first amount of friction, and wherein the wedging surface of the rope wedge frictionally engages the wedge countering surface with a second amount of friction, the second amount of friction being lower than the first amount of friction.

22.-23. (canceled)

24. A method of clamping a wire rope clamp onto a wire rope using a wire rope clamp according to claim 1, wherein a section of the rope, is inserted through the rope entrance opening of the holder of the rope clamp into the rope wedge channel so that a section of the rope extends through the interspace between the rope clamping surface of the rope wedge and the rope supporting surface of the holder, and wherein the rope is retracted so that the rope engages the rope wedge via the rope clamping surface and entrains the rope wedge so that the wedging surface of the rope clamp is pulled into engagement with the wedge countering surface and the rope clamping surface of the rope wedge clamps the section of the rope onto the rope supporting surface of the holder.

25. (canceled)

26. The method according to claim 24, further comprising, after inserting the rope through the rope entrance opening, and prior to the rope being retracted, coupling the rope to the rope wedge, and subsequently bending the rope towards the rope wedge.

27.-28. (canceled)

29. The method according to claim 24, further comprising positioning an auxiliary wedge providing the countering surface between the rope wedge and an auxiliary wedge countering surface of the holder prior to retracting the rope.

30. A method for unclamping a wire rope clamp from a wire rope, wherein the wire rope is clamped between a rope supporting surface of a holder of the wire rope clamp and a rope clamping surface of a rope wedge, which rope wedge is at least partially positioned in a rope wedge channel of the holder together with an auxiliary wedge, the method comprising steps of:
releasing a clamped connection between the auxiliary wedge, the holder, and the rope wedge; and
removing the wire rope from the rope wedge channel.

31. The method according to claim 30, wherein the wire rope clamp was clamped on the wire rope by inserting a section of the rope through the rope entrance opening of the holder of the rope clamp into the rope wedge channel so that a section of the rope extends through an interspace between the rope clamping surface of the rope wedge and the rope supporting surface of the holder, and wherein the rope is retracted so that the rope engages the rope wedge via the rope clamping surface and entrains the rope wedge so that a wedging surface of the rope clamp is pulled into engagement with a wedge countering surface and the rope clamping surface of the rope wedge clamps the section of the rope onto the rope supporting surface of the holder, and further comprising positioning the auxiliary wedge providing the countering surface between the rope wedge and an auxiliary wedge countering surface of the holder prior to retracting the rope.

32. The method according to claim 29, further comprising removing the auxiliary wedge and the rope wedge from the rope wedge channel.

33. The method according to claim 29, wherein the holder of the wire rope clamp comprises the releasable auxiliary wedge, and the countering surface is provided on the auxiliary wedge, which auxiliary wedge is arranged between the rope wedge and an auxiliary wedge countering surface of the holder.
